(19) United States
(12) Patent Application Publication
(10) Pub. No.: US 2008/0028074 A1
(43) Pub. Date: Jan. 31, 2008

(54) Supplemental Content Triggers having Temporal Conditions

(75) Inventor: Edward A. Ludvig, Redwood City, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/460,721

(22) Filed: Jul. 28, 2006

(51) Int. Cl. G06F 15/173

(52) U.S. Cl. 709/226

(57) ABSTRACT

Supplemental content triggers having temporal conditions described. In an implementation, a determination is made as to whether a trigger has expired that is included in content and that relates to supplemental content. When the trigger has expired, functionality relating to the supplemental content is disabled.

### BACKGROUND

The saturation of digital video recorders in the marketplace is ever increasing. Digital video recorders, for instance, may be used to increase the range of functionality in the recordation and playback of content. One such example is through the use of “trick modes”, such as the ability to pause content that is currently being broadcast and which allows users to watch the content, while still in progress, from the point it was paused. The digital video recorder plays back the content from memory, starting at the pause event, while continuing to record the currently-broadcast content in the disk memory. Additionally, the digital video recorder may support other trick modes, such as rewinding, fast forwarding a stored program, slow motion playback, and the like. Thus, users are able to “time-shift” the output of content, such as by watching earlier portions of a currently broadcast television program while the television program is also being stored in the memory.

The functionality provided by content that is stored by the digital video recorder is also ever increasing. For example, content may be configured for concurrent output with supplemental content that is configured to add to the user's overall experience with the content, such as through the display of statistics relating to a currently broadcast sporting event. However, because the users are able to time-shift the output of the content, the supplemental content may not have continued relevancy to the user and/or a provider of the content.

### SUMMARY

Supplemental content triggers having temporal conditions described. In an implementation, a determination is made as to whether a trigger has expired that is included in content and that relates to supplemental content. When the trigger has expired, functionality relating to the supplemental content is disabled.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an exemplary implementation that is operable to employ techniques related to content that has temporally-limited triggers. In the illustrated implementation, the environment includes a content provider that is communicatively coupled to a client over a network.

FIG. 2 is an illustration of an exemplary environment showing a client of FIG. 1 in greater detail.

FIG. 3 is a flow diagram depicting a procedure in an exemplary implementation in which functionality of supplemental content is disabled when a determination is made that a trigger which corresponds to the supplemental content has expired.

FIG. 4 is a flow diagram depicting a procedure in an exemplary implementation, in which, application modules are identified that consume supplemental content. The supplemental content and triggers are filtered from the content and passed to the application modules.

### DETAILED DESCRIPTION

Overview

Digital video recorders are used by numerous users to increase the range of functionality in the recordation and playback of content, such as through the use of “trick modes” to pause content that is currently being broadcast and/or watch content at a later time when desired. In this way, users are able to “time-shift” the output of content.

In some instances, however, the content that is being broadcast may support supplemental content, such as to increase the “richness” of the overall experience by the viewer. However, this supplemental content may not have continued relevancy at a later point in time. For example, a television program may have supplemental content that supports voting on participants in the program. The votes may then be collected by a content provider and tallied. However, the viewer may be watching a time-shifted output of the content using a digital video recorder and therefore the tallying of the votes may serve little or no purpose. A variety of other examples are also contemplated.

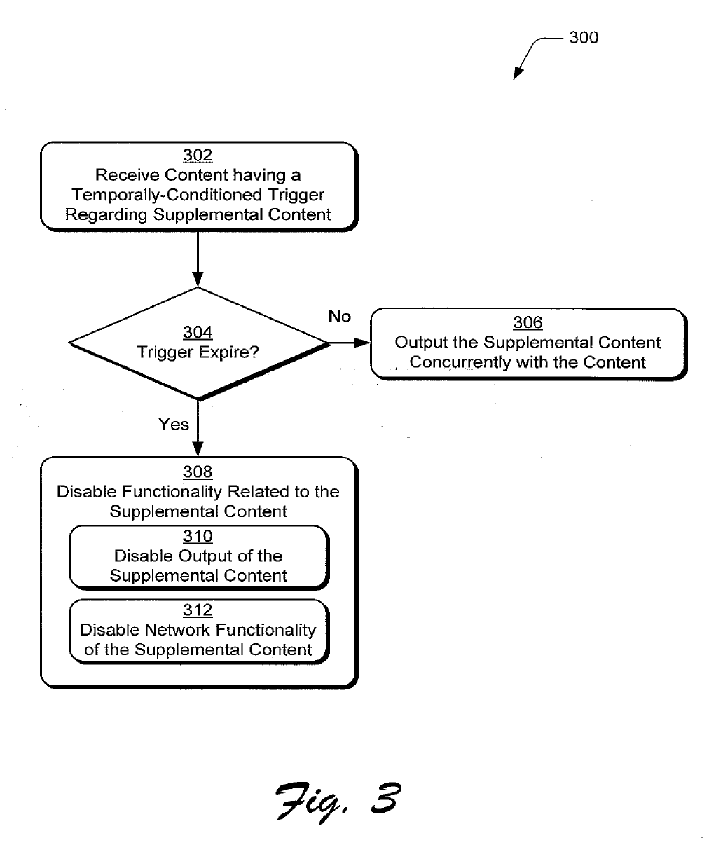

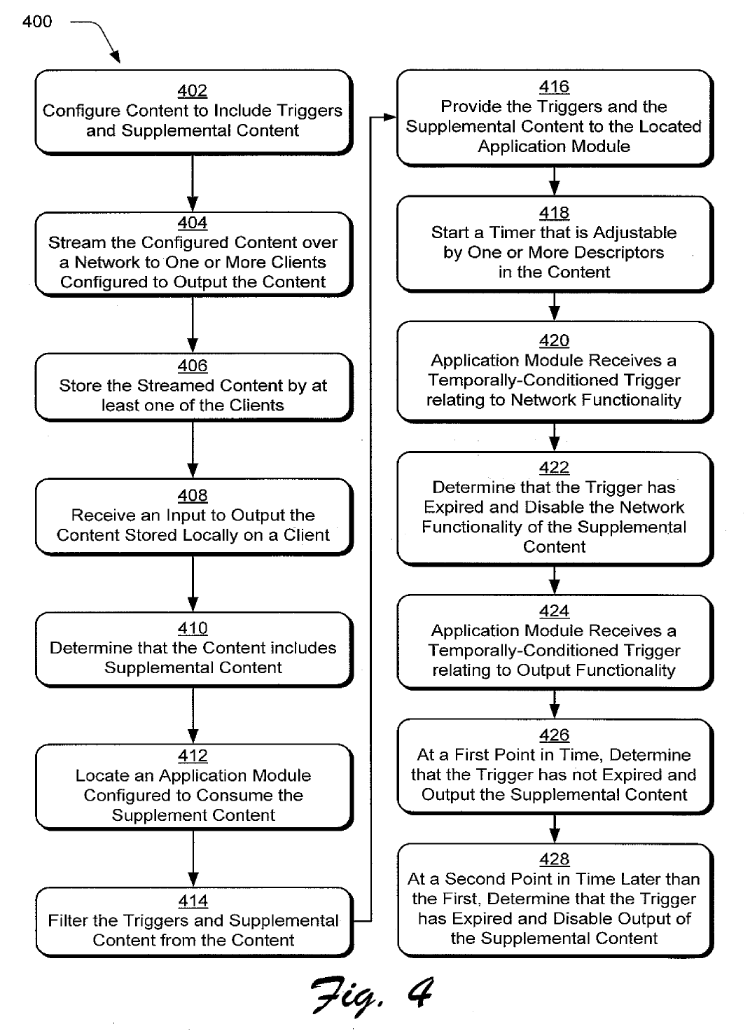

Accordingly, techniques are described in which content includes temporally-conditioned triggers that relate to the supplemental content. For example, triggers in the content which are to cause output of the supplemental content may be configured to expire after a period of time, e.g., after voting for a particular television program has closed. Therefore, the supplemental content in this example is output when relevant, even when recorded by a digital video recorder, but is not output when it is no longer relevant. A variety of other techniques may also be employed to disable functionality related to the supplemental content based on temporally-limited triggers (e.g., to disable network functionality of the supplemental content such that the user may vote but those votes are not tallied) further discussion of which may be found in relation to FIGS. 3-4.

In the following discussion, an exemplary environment is first described that is operable to perform techniques relating to content that has temporally-limited triggers. Procedures are then described which may be employed by the environment as well as in other environments.

Exemplary Environment

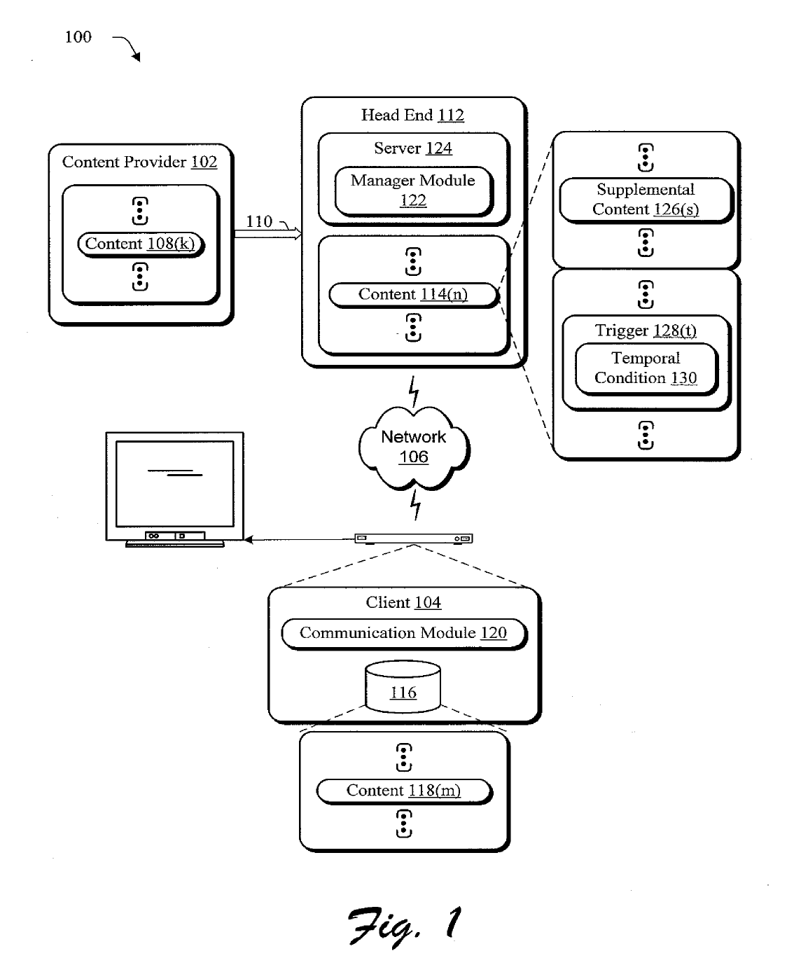

FIG. 1 is an illustration of an environment 100 in an exemplary implementation that includes a content provider 102 that is communicatively coupled to a client 104 over a network 106. The client 104 may be configured in a variety of ways. For example, the client 104 may be configured as a computer that is capable of communicating over the network 106, such as a desktop computer, a mobile station, an entertainment appliance, a set-top box communicatively coupled to a display device as illustrated, a wireless phone, and so forth. Thus, the client 104 may range from a full resource device with substantial memory and processor resources (e.g., television-enabled personal computers, television recorders equipped with hard disk) to a low-resource device with limited memory and/or processing resources (e.g., traditional set-top boxes). For purposes of the following discussion, the client 104 may also relate to a person and/or entity that operates the client. In other words, client 104 may describe a logical client that includes a user, software and/or a machine. Although one client 104 is illustrated, the client 104 may be representative of a plurality of clients that may be communicatively coupled to the network 106. The network 106 is illustrated as the Internet, and may include a variety of other networks, such as an intranet, a wired or wireless telephone network, a broadcast network with a backchannel to provide two-way communication, and so forth. Additionally, although the network 106 is illustrated as a single network, network 106 may be representative of a plurality of networks.

The content provider 102 includes a plurality of content 108(k), where “k” can be any integer from 1 to “K”. The content 108(k) may include a variety of data, such as television programming, video-on-demand (VOD), one or more results of remote application processing, and so on. The content 108(k) is communicated over a network 110 to a head end 112. The network 110 may be the same as or different from network 106.

Content 108(k) communicated from the content server 112 over the network 110 is received by the head end 112 and stored as content 114(n), where “n” can be any number from “1” to “N”. The content 114(n) may be the same as or different from the content 108(k) received from the content provider 102. The content 114(n), for instance, may include additional data for broadcast to the client 104. For example, the content 114(n) may include electronic program guide (EPG) data from an EPG database for broadcast to the client 104 utilizing a carousel file system. The carousel file system repeatedly broadcasts the EPG data over an out-of-band (OOB) channel to the client 104 over the network 106. Distribution from the head end 112 to the client 104 may be accommodated in a number of ways, including cable, RF, microwave, digital subscriber line (DSL), and satellite.

The client 104 may be configured in a variety of ways to receive the content 114(n) over the network 106. As illustrated, the client 104 may be configured as a set-top box that is communicatively coupled to a display device. The client 104 includes hardware and software to transport and decrypt content 114(n) received from the head end 112 for rendering by the illustrated display device. Although a display device is shown, a variety of other output devices are also contemplated, such as speakers.

The client 104 may also include digital video recorder (DVR) functionality. For instance, the client 104 may include a storage device 116 to record content 114(n) received from the network 106 for output to and rendering by the display device. The storage device 116 may be configured in a variety of ways, such as a hard disk drive, a removable computer-readable medium (e.g., a writable digital video disc), and so on. Content 118(m), where “m” can be any number from “1” to “M”, that is stored in the storage device 116 of the client 104 may be copies of the content 114(n) that was streamed from the head end 112. Additionally, content 118(m) may be obtained from a variety of other sources, such as from a computer-readable medium that is accessed by the client 104, and so on.

The client 104 includes a communication module 120 that is executable on the client 104 to control content playback on the client 104, such as through the use of one or more “trick modes”. The trick modes may provide non-linear playback of the content 118(m) (i.e., time shift the playback of the content 118(m)) such as pause, rewind, fast forward, slow motion playback, and the like. For example, during a pause, the client 104 may continue to record the content 114(n) in the storage device 116 as content 118(m). The client 104, through execution of the communication module 120, may then playback the content 118(m) from the storage device 116, starting at the point in time the content 118(m) was paused, while continuing to record the currently-broadcast content 114(n) in the storage device 116 from the head end 112.

When playback of the content 118(m) is requested, the communication module 120 is executed on the client 104 to retrieve the content 118(m). The communication module 120 may also restore the content 118(m) to the original encoded format as received from the content provider 102. For example, when the content 118(m) is recorded on the storage device 116, the content 118(m) may be compressed. Therefore, when the communication module 120 retrieves the content 118(m), the content 118(m) is decompressed for rendering by the display device.

The head end 112 is illustrated as including a manager module 122 that is being executed on a server 124. The manager module 122 is representative of functionality to configure content 114(n) for output (e.g., streaming) over the network 106 to the client 104. The manager module 112, for instance, may configured content 108(k) received from the content provider 102 to be suitable for network 106 transmission, such as to “packetize” the content for distribution over the Internet, configuration for a particular broadcast channel, and so on.

The manager module 122 may also configure the content 114(n) to include one or more items of supplemental content 126(s) (where “s” can be any integer from one to “S”) and one or more triggers 128(t) (where “t” can be any integer from one to “T”). The triggers 128(t), for example, may be placed in the content 114(n) such that as the content 114(n) is output, corresponding supplemental content 126(s) referenced by the trigger 128(t) may also be output. As previously described, however, supplemental content 126(s) may not have continued relevancy at a later point in time. In such an instance, the manager module 122 may insert triggers 128(t) having a temporal condition 130 that disables functionality related to the supplement content 126(s), such as to disable output of the supplemental content 126(s), disable one or more features of the supplemental content 126(s) when it is output, and so on. In this way, when output of the content by the client 104 is time-shifted, the supplemental content 126(s) may have continued relevancy, further discussion of which may be found in relation to the following figure.

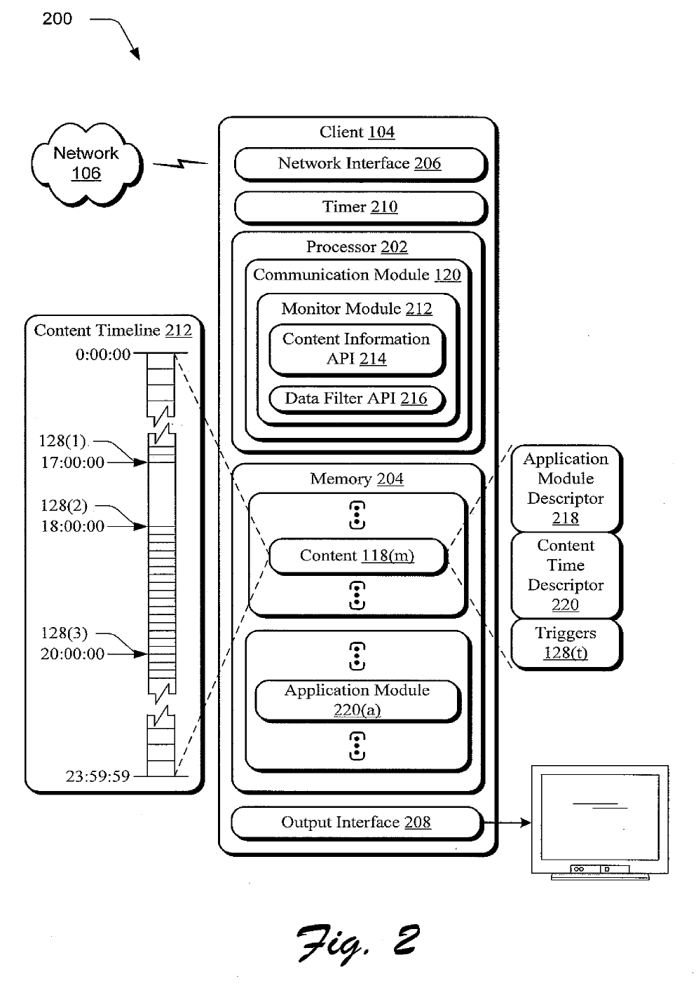

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer-readable media, further discussion of which may be found in relation to FIG. 2. The features of the techniques involving temporally-conditioned triggers described below are platform-independent, meaning that the techniques may be implemented on a variety of commercial computing platforms having a variety of processors.

FIG. 2 is an illustration of an exemplary environment 200 showing the client 104 of FIG. 1 in greater detail. The client 104 of FIG. 2 is illustrated as a client device that includes a processor 202 and memory 204. The communication module 120 is illustrated as being executed on the processor 202 and is storable in memory 204. Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 204 is shown, a wide variety of types and combinations of memory may be employed, such as random access memory (RAM), hard disk memory, removable medium memory, and other types of computer-readable media.

The client 104 is further illustrated as including a network interface 206, an output interface 208 and a timer 210. The network interface 206 is configured to provide network 106 communication, such as to communicate over the Internet, tune to broadcast channels, and so on. The output interface 208 is configured to output content 118(m) for rendering by an output device, such as a display device, speakers and so on.

The client 104 may obtain the content 118(m) from a variety of sources. For example, the client 104 may execute the communication module 120 to retrieve content 118(m) from memory 204. The retrieved content 118(m) may then be played back using an output interface 208 for rendering on the illustrated display device. As previously stated, the communication module 120, when executed on the processor 202, may provide one or more trick modes for the control of content playback over the output interface 208, such as pause, rewind, fast forward, slow motion playback, and the like.

The client 104, through execution of the communication module 120, is also capable of requesting content 114(n) from the head end 112 over the network 106. For instance, the communication module 120, when executed on the processor 202, may send a request via the network 106 to the head end 112 to request content 114(n) for broadcast over the network 106. For example, the content 114(n) may be recorded at the request of the client 104 and therefore the head end 112 in this example provides network digital video recorder (NDVR) functionality.

Thus, through execution of the communication module 120, the client 104 may playback locally-stored content 118(m), content 114(n) that is stored remotely over the network 106, and may even control the recordation and playback of the remotely stored content 114(n) to the client 104. A variety of other examples are also contemplated.

As previously stated, because a user can time-shift content playback, supplemental content 126(s) may no longer be relevant. Therefore, triggers 128(t) that are included in the content 118(m) that are used in the output of supplemental content 126(s) may have temporal-limitations expired. For example, the content 118(m) may be represented as a content timeline 212 having triggers 128(1), 128(2) and 128(3). The triggers 128(1)-128(3) are inserted to indicate that corresponding supplemental content 126(s) is to be output at a particular time, e.g., one minute from when the triggers 128(1)-128(3) are encountered as the content 118(m) is streamed, through inclusion of a timestamp that specifies when to execute the trigger payload, and so on. For example, output of the trigger may be performed through tracking of a current timecode in the content through use of timeline descriptors. Because the supplement content may have relevancy for a limited amount of time, one or more of the triggers 128(1)-128(3) may be configured to expire at the end of this relevancy, such as through inclusion of an “expiration date”. Output of the supplemental content in response to the triggers may be performed in a variety of ways.

The communication module 120, for instance, may include a monitor module 212 which is representative of functionality that monitors content output by the client 104 for corresponding supplemental content. The monitor module 212 is illustrated as relying on a content information application programming interface (API) 214 and a data filter API 216. The content information API 214 is used to determine whether the content 118(m) includes supplemental content and what type of supplemental content is included. For example, the content information API 214 may determine which type of supplemental content is included through use of an application module descriptor 218 which identifies which of the one or more application modules 220(a), illustrated as stored in memory 204, is executable to interpret the supplemental content. The data filter API 216 is executable to remove the supplemental content and triggers 128(t) from the content 118(m) and expose it to the corresponding application module 220(a).

To preserve synchronization of the triggers, the content 118(m) may also include one or more content time descriptors 220 at frequent intervals in the content so that an instance may be sampled upon playback of the content. In other words, the timeline descriptors 220 describe a current timecode in the content. For example, the communication module 120 may start the timer 210 when output of the content 118(m) is begun and update the timer 210 according to content time descriptors 220 included in the content timeline 212. This may also be used to synchronize output of the content 118(m) and the supplemental content during “time-shifting” of the output of the content, during “live” playback, and so on. Although the timer 210 is illustrated as separate from the processor 202 and memory 204, the timer 210 may be implemented as hardware and/or software that is executed on the processor 202. A variety of other examples are also contemplated without departing from the spirit and scope thereof further discussion of which may be found in relation to the following figures.

Exemplary Procedures

The following discussion describes techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the system 200 of FIG. 2.

FIG. 3 depicts a procedure 300 in an exemplary implementation in which functionality of supplemental content is disabled when a determination is made that a trigger which corresponds to the supplemental content has expired. Content is received that has a temporally-conditioned trigger (block 302). For example, the content may be a television program streamed from the head end 112 over the network 106 to the client 104 and stored locally by the client 104 in storage 116, Output of the locally-stored content may then be requested. In another example, the content 114(n) is streamed over the network 106, the content being stored by the head end 112 as a network DVR. A variety of other examples are also contemplated.

A determination is made as to whether the trigger has expired (decision block 304). The trigger 128(t), for instance, may be stored as metadata included with the content 114(n) that indicates a point in time, after which, the trigger is to expire. This indication may be performed in a variety of ways, such as through use of a date and time (e.g., Jul. 4, 2006, 12:01 am), after a predetermined amount of time has expired (e.g., 30 days after recordation of the content, storage of the content or broadcast of the content), and so on.

When the trigger has not expired (“no” from decision block 304), the supplemental content is output concurrently with the content (block 306). For example, the supplemental content may be displayed as a translucent overlay over at least a portion of the content, may be displayed in a split-screen format, a pop-up window, and so forth. The supplemental content, for instance, may relate to content that provides viewers with an opportunity to vote for a favorite contestant. The voting may “close” after an amount of time, e.g., after a particular date and time and so on. Therefore, the trigger may be set to correspond to this amount of time (e.g., to include an expiration time/date of when voting is to close) such that votes may continue to be collected through interaction with the supplemental content, e.g., while the expiration date/time has not elapsed. A variety of other instances are also contemplated.

When the trigger has expired (“yes” from decision block 304), functionality related to the supplemental content is disabled (block 308). A variety of functionality may be disabled in a variety of ways, such as to disable output of the supplemental content (block 310), disable network functionality of the supplemental content (block 312), and so forth. Continuing with the previous example, the trigger for collecting votes may have expired and therefore the supplemental content which relates to collecting votes is not output. In another instance, the content provider may wish to give the feeling to the viewer that the votes “still matter” and therefore outputs the supplemental content but does not communicate an input (e.g., the vote) over the network 106. A variety of other examples are also contemplated.

FIG. 4 depicts a procedure 400 in an exemplary implementation, in which, application modules are identified that consume supplemental content and the supplemental content and triggers are filtered from the content and passed to the application modules. Content is configured to include triggers and supplemental content (block 402). A technician working at the head end 112, for example, may receive content 108(k) and interact with the content through use of a user interface output by the manager module 112 to insert triggers relating to particular supplemental content 126(s). This output may be performed in a variety of ways, such as through display of a content timeline 212. A variety of other examples are also contemplated.

The configured content is streamed over a network to one or more clients configured to output the content (block 404), such as by providing a broadcast to clients 104 configured as digital video recorders. The streamed content is then stored by at least one of the clients (block 406), such as to a hard disk drive in the digital video recorder example.

An input is received to output the content that is stored locally on the client (block 408), such as by selecting a “play” button on a remote control through interaction with a menu. A determination is then made that the content includes supplemental content (block 410). For example, when the input is received to play content 118(m) from storage 116, the monitor module 212 may “wake” and use the content information API 214 to determine whether the content is interactive.

When the content is determined to be interactive, an application module is located that is configured to consume the supplemental content (block 412). The content information API 214, for example, may expose an application module descriptor 218 which may be utilized to locate an application module 220(a) configured to interpret the supplemental content for output.

Triggers and supplemental content are filtered from the content (block 414) and provided to the located application module (block 416). For example, the communication module 120 may parse the content 118(m) to find triggers and supplemental content that is consumable by the application module. In this way, the application modules may be configured to consume the supplemental content without “understanding” different formats used by the content 118(m). In another example, the parsing is done by the application modules 220(a) themselves.

A timer is started that is adjustable by one or more descriptors in the content (block 418). As previously described in relation to FIG. 2, for instance, the timer 210 may be started to coordinate output of the content with the supplemental content.

The application module receives a temporally-conditioned trigger relating to network functionality (block 420). In this instance it is determined that the trigger has expired and therefore the network functionality of the supplemental content is disabled (block 422).

The application module may also receive a temporally-conditioned trigger relating to output functionality (block 426). At a first point in time, it is determined that the trigger has not expired and therefore the supplemental content is output (block 426). However, at a second point in time later than the first, it is determined that the trigger has expired and therefore execution of the supplemental content is disabled (block 428), e.g., the trigger payload is not output. Thus, the functionality of the supplemental content may be dependent on whether the trigger has expired.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
determining whether a trigger has expired that is included in content and that relates to supplemental content; and
when the trigger has expired, disabling functionality relating to the supplemental content.

2. A method as described in claim 1, wherein the functionality is disabled such that at least one function of the supplemental content relating to network access is disabled.

3. A method as described in claim 1, wherein:
the at least one function includes communication of an input received by the client over a network; and
the input is received through user interaction with the supplemental content.

4. A method as described in claim 3, wherein:
the content is a television program;
the supplement content is configured to accept a vote relating to the television program; and
the network functionality is configured to communicate the vote over the network.

5. A method as described in claim 1, wherein the functionality is disabled such that output of the supplemental content is not performed.

6. A method as described in claim 1, wherein the content is streamed to the client over a network from a head end and stored locally on the client.

7. A method as described in claim 1, wherein the client is configured to include digital video functionality to record television programming.

8. A method as described in claim 1, further comprising when the trigger has not expired, enabling functionality relating to the supplemental content that corresponds to the trigger.

9. One or more computer-readable media comprising executable instructions that, when executed, direct a client to determine whether content that was streamed over a network includes supplemental content, and if so:
locate an application module configured to consume the supplemental content; and
filter triggers having temporal conditions and the supplemental content from the content and provide the filtered triggers and the supplemental content via an application programming interface to the located application module.

10. One or more computer-readable media as described in claim 9, wherein the content is stored locally on the client in non-volatile memory.

11. One or more computer-readable media as described in claim 9, wherein the located application module is configured to determine whether at least one of the triggers has expired, and if not, output the supplemental content concurrently with the content.

12. One or more computer-readable media as described in claim 9, wherein the located application module is configured to determine whether at least one of the triggers has expired, and if so, disable functionality relating to the supplemental content.

13. One or more computer-readable media as described in claim 12, wherein the functionality is disabled such that at least one function of the supplemental content relating to network access is disabled.

14. One or more computer-readable media as described in claim 12, wherein:
the at least one function includes communication of an input received by the client over a network; and
the input is received through user interaction with the supplemental content.

15. One or more computer-readable media comprising computer executable instructions that, when executed, direct a computer to configure video content to include triggers and supplemental content, wherein at least one of the triggers includes a temporal condition such that when the trigger has expired functionality relating to the supplemental content is disabled.

16. One or more computer-readable media as described in claim 15, wherein the computer-executable instructions configure the video content to include triggers and supplemental content in response to user interaction with a user interface showing a timeline of the content.

17. One or more computer-readable media as described in claim 15, wherein the video content is configured as a television program or a movie.

18. One or more computer-readable media as described in claim 15, wherein at least one of the triggers is configured such that when the trigger expires network functionality of the supplemental content is disabled.

19. One or more computer-readable media as described in claim 15, wherein at least one of the triggers is configured such that when the trigger expires output functionality of the supplemental content is disabled.

20. One or more computer-readable media as described in claim 15, wherein the computer-executable instructions configure the video content to include the supplemental content and the triggers to be suitable to be streamed over a network for local storage on a client.
